(19) United States
(12) Patent Application Publication
(10) Pub. No.: US 2008/0137654 A1
(43) Pub. Date: Jun. 12, 2008

(54) METHOD OF MANAGING SIGNALING MESSAGE IN PATH-BASED SIGNALED PATHS TO MPLS-ENABLED CORE NETWORK

(75) Inventors: Byung Joon LEE, Daejeon-city (KR); Seung Hyun YOON, Daejeon-city (KR); Youngseok LEE, Daejeon-city (KR)

Correspondence Address: RABIN & Berdo, PC, 1101 14TH STREET, NW, SUITE 500, WASHINGTON, DC, 20005, US

(73) Assignee: Electronics and Telecommunication Research Institute, Daejeon-City (KR)

(21) Appl. No.: 11/938,111

(22) Filed: Nov. 9, 2007

(30) Foreign Application Priority Data
Dec. 6, 2006 (KR) 10-2006-0123396
Oct. 2, 2007 (KR) 10-2007-0099370

(51) Int. Cl. H04L 12/56

(52) U.S. Cl. 370/389; 370/255; 370/395.5

(57) ABSTRACT

Provided is a method of processing a signaling message between a subscriber network supporting path-coupled signaling and a multi-protocol label switching (MPLS) label-switched path (LSP)-based transmission network. According to the method, it is possible to process a path-coupled signaling message generated in the transmission network while corresponding them to a plurality of MPLS LSPs that have been set in the transmission network. Thus there is no need to additionally generate or cancel an MPLS LSP, and therefore the load onto the transmission network can be effectively reduced thereby improving network scalability. Also, it is possible to guarantee the QoS (quality of service) for each node-to-node path by using MPLS LSP, thus allowing a QoS-based service to be provided. Accordingly, the method can be applied to a BcN (Broadband Convergent Network) or a NGN (Next-Generation Network).

### CROSS-REFERENCE TO RELATED PATENT APPLICATIONS

This application claims the benefit of Korean Patent Application No. 10-2006-0123396, filed on Dec. 6, 2006 and Korean Patent Application No. 10-2007-0099370, filed on Oct. 2, 2007 in the Korean Intellectual Property Office, the disclosures of which are incorporated herein in their entirety by reference.

### BACKGROUND OF THE INVENTION

1. Field of the Invention

The present invention relates to a system and method for supporting a link between a transmission network supporting a path-coupled signaling and a broadband convergent network (BcN) transmission network that is designed based on multi-protocol label switching (MPLS) label-switched path (LSP).

The present invention is derived from the research performed as a part of the information technology (IT) new growth power core technology development business, which was hosted by the Ministry of Information and Communications Republic of Korea (MIC) and the Institute for Information Technology Advancement (IITA) [Task management No.: 2005-S-097-02, entitled “BcN integrated network control and QoS/TE management technology development].

2. Description of the Related Art

Path-coupled signaling is a signaling system delivered in a path in which internet traffic is to be transmitted, and mainly used to set a path and to reserve or cancel reservation of QoS resources for a preset path. An RSVP (ReSerVation Protocol) and a GPRS (General Packet Radio Service) Context have currently been used as a such signaling system.

Path-coupled signaling is generally performed in a uni-direction and thus is used in order to set or cancel setting of a unidirectional path and to reserve or withdraw resources. If a signaling message for path setting and resources reservation and a response message thereto are exchanged between a transmitter and a receiver, a unidirectional path is set from the transmitter to the receiver accordingly. If a signaling message for path canceling and resource withdrawal is exchanged between the transmitter and the receiver, a predetermined unidirectional path is canceled and resources allocated thereto are withdrawn accordingly. Thus path-coupled signaling must be performed twice in order to set or cancel a bi-directional path and to reserve or withdraw resources. Also, signaling is performed in a uni-direction, and thus a subject and an object of the signaling are respectively a transmitter and a receiver.

Multi-protocol label switching is a common term of technology available for setting and canceling an MPLS Label-switched path in the Internet network. A label-switched path (LSP) is a term of a virtual circuit that is set using MPLS. One MPLS LSP can be used to transmit packets, which are to be to the same destination and have the same traffic characteristics, at high speeds, and to guarantee the same QoS (quality of service) thereof.

Recently, as research has been actively conducted into integration of various fields of communications technologies by using an internet-protocol (IP)-based Internet, a demand for technology for processing services related to various types of wire/wireless terminals via a single transmission network has been increased.

Networks capable of supporting this technology are generally referred to as a BcN (Broadband Convergent Network) or a NGN (Next-Generation Network). Various types of wire/wired terminals, such as a mobile phone, a wire telephone, a VoD terminal, or a VoIP terminal, can be connected to such networks via a subscriber network. An increase in requirements for QoS leads to development of terminals having functions of network path setting and path-based resource reservation/canceling. Protocols for supporting such terminals include IP-based RSVP, and GPRS Session Management Signaling available in a GPRS network.

The above protocols are commonly used in order to set a path for delivering traffic generated by a terminal and reserve QoS resource for the path. However, if node-to-node resource reservation is performed using these protocols, the load on a transmission network increases.

If the transmission network is designed based on MPLS LSP, one LSP is required for one terminal at a transmitting side and one terminal at a receiving side for path setting and resource reservation when a resource for the transmission network is reserved using the protocols. However, in general, the capacity of one router that can process the MPLS LSP without increasing the load thereto is no more than several thousands LSP to several tens of thousands LSP. Thus if requests for path setting and resource reservation are directly transmitted to the transmission network, not only the performance of the network but also the scalability thereof may be degraded greatly. This is because in general, the total numbers of terminals to which services are provided via one BcN transmission network are more than several tens of thousands.

Accordingly, there is a growing need for development of technique of providing a service by corresponding a request for the same requirement for QoS and the same destination in terms of a subscriber network level to one MPLS LSP, rather than providing a service by making requests for path setting and resource reservation from various types of wire/wireless terminals have one-to-one correspondence to MPLS LSPs.

### SUMMARY OF THE INVENTION

The present invention provides a method of managing a signaling message between a subscriber network and a multi-protocol label switching (MPLS) label-switched path (LSP)-based transmission network, which is capable of not only easily forming a link between the subscriber network and the transmission network by effectively relaying a request for resource reservation from the subscriber network to the transmission network but also supporting path-coupled signaling in order to guarantee the QoS of traffic generated by a terminal, when providing a service to various types of wire/wireless terminals that support path-based resource reservation protocols, via the MPLS LSP-based transmission network.

According to an aspect of the present invention, there is provided a method of allowing a router located between a subscriber network supporting path-coupled signaling and a transmission network to process a signaling message delivered from the subscriber terminal, together with a resource management system managing resources connecting the subscriber network and the transmission network, the method comprising the router transforming a path-coupled signaling message received from the subscriber terminal, and delivering the transformed message to the resource management system; the resource management system receiving the transformed message, performing an operation instructed in the signaling message, and delivering a response message to the router; and the router transforming the response message into a path-coupled signaling protocol response message corresponding to the subscriber terminal, and delivering the transformed response message to the subscriber terminal.

According to another aspect of the present invention, there is provided a method of allowing a first resource management system managing resources connecting a first subscriber network supporting path-coupled signaling and a transmission network to process a message transmitted from a router located between the first subscriber network and the transmission network, the method comprising receiving a transformed signaling message from the router; identifying a second subscriber network in which a destination terminal of the signaling message is located, and detecting a second resource management system and a second transmission network boundary corresponding to the second subscriber network, based the signaling message; if the signaling message contains information for path setting and resource reservation, detecting a bandwidth of a path requested in the signaling message and QoS (quality of service) characteristics of packets that are to be transmitted via the path, from the contained information; searching for a MPLS (Multi-Protocol Label Switching) LSP (Label-Switched Path) from among MPLS LSPs connecting the router and the second transmission network boundary router corresponding to the second subscriber network, adding the searched result to the received message, and then delivering the resultant message to the second resource management system corresponding to the second subscriber network; if a response message to the delivered message indicates success, reducing a bandwidth available of the searched MPLS LSP, and generating information for configuring the routers in order to transmit packets received from the subscriber network via the searched MPLS LSP; and adding the generated information to a response message and then delivering the response message to the router.

According to another aspect of the present invention, there is provided a method of allowing a first resource management system connected between a subscriber network supporting path-coupled signaling and a transmission network to process a transformed signaling message received from a second resource management system, the method comprising receiving a transformed signaling message from the second resource management system; if the received signaling message requests path setting and resource reservation, extracting multi-protocol label switching (MPLS) label-switched path (LSP) information and information regarding a bandwidth and QoS (quality of service) characteristics of a path that is to be set from the signaling message; extracting information regarding a transmitter terminal and a receiver terminal of the signaling message from the signaling message, and identifying a boundary router at a receiving side; sending the boundary router with a command message instructing a path-coupled signaling message, which is terminated by a subscriber network terminal connected to the boundary router, to be transmitted using the extracted information; if a response message to the command message indicates a success, extracting information regarding a subscriber network path formed in the subscriber network from the signaling message; and transmitting a message to the second resource management system at the transmitting side, so that packets are to be delivered from the transmitter terminal to the receiver terminal according to the extracted bandwidth and QoS characteristics.

Accordingly, according to the present invention, it is possible to process a path-coupled signaling message generated in a transmission network by corresponding them to a plurality of MPLS LSPs that exist in the transmission network. Thus, since there is no need to create or cancel MPLS LSPs, the load on the transmission network can be effectively reduced in order to improve network scalability. Also, since the QoS of respective node-to-node paths can be guaranteed using an MPLS LSP, it is possible to provide a QoS-based service. Therefore, the present invention can be applied to a BcN (Broadband convergent network) and a next-generation network (NGN).

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of a network according to an embodiment of the present invention;

FIG. 2 is a flowchart illustrating a method of allowing a transmission network boundary router to process a path-coupled signaling message according to an embodiment of the present invention;

FIGS. 3A through 3C are flowcharts illustrating a method of allowing a resource management system to process a transformed path-coupled signaling message received from a transmission network boundary router according to an embodiment of the present invention; and

FIGS. 4A through 4C are flowcharts illustrating a method of allowing a resource management system to process a transformed path-coupled signaling message received from another resource management system according to an embodiment of the present invention.

### DETAILED DESCRIPTION OF THE INVENTION

Hereinafter, exemplary embodiments of the present invention will be described in greater detail with reference to the accompanying drawings.

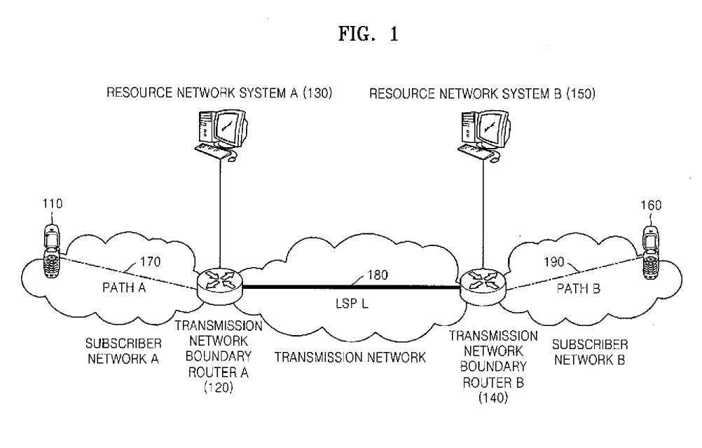

FIG. 1 is a diagram of a system capable of supporting a link between a subscriber network supporting path-coupled signaling and a multi-protocol label switching (MPLS) label-switched path (LSP)-based transmission network according to an embodiment of the present invention.

Referring to FIG. 1, the system includes a transmission network boundary router A 120 and a resource management system A 130. In brief, if a specific subscriber terminal 110 in a subscriber network A transmits a path-coupled signaling message via a specific path A 170, the transmission network boundary router A 120 connected to the subscriber network A transforms this message and delivers it to the resource management system A 130.

The resource management system A 130 identifies a subscriber network B where a subscriber terminal 160 at a receiving side is located, a transmission network boundary router B 140 connected to the subscriber network B, and a resource management system B 150 connected to the transmission network boundary router B 140, based on the transformed message. After the identification, the resource management system A 130 transmits the transformed message to the resource management system B 150 in order to request path-coupled signaling in a path B 190 from the boundary router B 140 at the receiving side to the subscriber terminal 160 at the receiving side.

Thus if one subscriber terminal begins path-coupled signaling, path-coupled signaling is generated in two subscriber networks. The two subscriber networks may be identical networks, or different networks that use different techniques of setting a path and allocating a resource. Accordingly, a link between the two subscriber networks must be performed by boundary routers and resource management systems in a transmission network. To this end, the operations of a transmission network boundary router and a resource management system will now be described.

First, the transmission network boundary router receives a path-coupled signaling message from a subscriber terminal connected to a subscriber network, transforms the message so that a resource management system can understand it, and then transmits the transformed message to the resource management system; begins path-coupled signaling for a specific terminal in a specific subscriber network in response to a request message from the resource management system; transmits a specific type of a packet delivered from the specific terminal in the specific subscriber network via a specific MPLS LSP in a transmission network; and transmits a packet delivered via the MPLS LSP via the transmission network in a path in a subscriber network to which the transmission network boundary router is connected.

The resource management system receives the path-coupled signaling message from the transmission network boundary router and then determines a terminal at a receiving side, a subscriber network where the terminal is located, and a transmission network boundary router and a resource management system connected to the subscriber network; instructs that the transmission network boundary router connected to the subscriber network begin path-coupled signaling so that path-coupled signaling can be performed with respect to the terminal at the receiving side and the subscriber network; and sets the transmission network boundary router so that a specific type of a packet generated by a specific terminal in a specific subscriber network can be transmitted using an MPLS LSP in a specific transmission network.

The operations of a transmission network boundary router and a resource management system based on the environment and the system illustrated in FIG. 1 will now be described in greater detail.

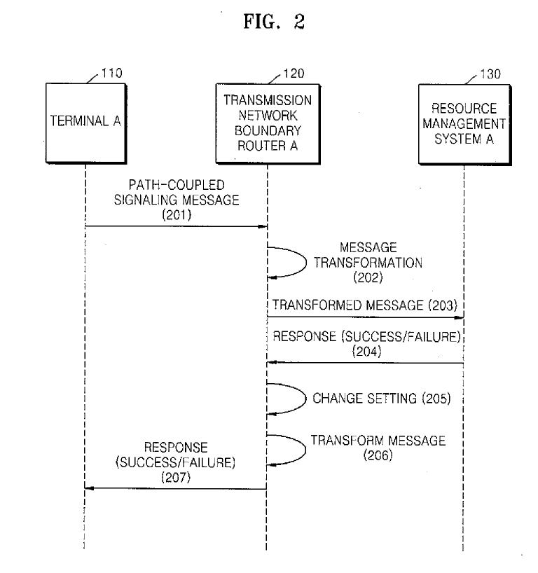

FIG. 2 is a flowchart illustrating a method of allowing a transmission network boundary router A 120 to process a path-coupled signaling message received from a subscriber terminal 110 according to an embodiment of the present invention.

If receiving a path-coupled signaling message from the subscriber terminal 110 (operation 201), the router A 120 appropriately transforms the signaling message (operation 202) and provides the transformed message to a resource management system A 130 (operation 203) in order to transmit a response message to the signaling message to the subscriber terminal 110 (operation 207). To this end, the router A 120 can support path-coupled signaling protocol functions, such as an RSVP (ReSerVation Protocol) or a GPRS (General Packet Radio Service) session management signaling, which are used in a subscriber network.

The resource management system A 130 receives the transformed message, performs an operation instructed in the signaling message, and then transmits a response message to the signaling message to the router A 120 (operation 204). The signaling message may be a message requesting path setting and resource reservation or canceling of a set path and resource withdrawal.

If the response message transmitted in operation 204 is a “SUCCESS” response message indicating that the operation instructed in the transformed signaling message has been successfully performed, this message may contain various information for changing router setting. In this case, the router A 120 appropriately changes its setting based on the various information in order to construct the router A 120 so that packets from the terminal 110 can or cannot be transmitted via a specific MPLS LSP in a transmission network (operation 205).

If the response message transmitted in operation 204 is not the “SUCCESS” response message, the setting of the router A 120 is not changed.

Thereafter, the response message transmitted in operation 204 is transformed into a path-coupled signaling protocol response message that the subscriber terminal 110 can understand (operation 206) and then is transmitted to the subscriber terminal 110 (operation 207).

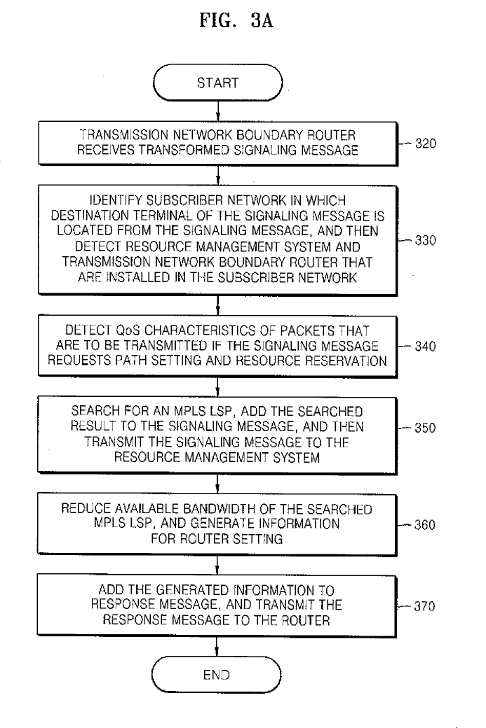

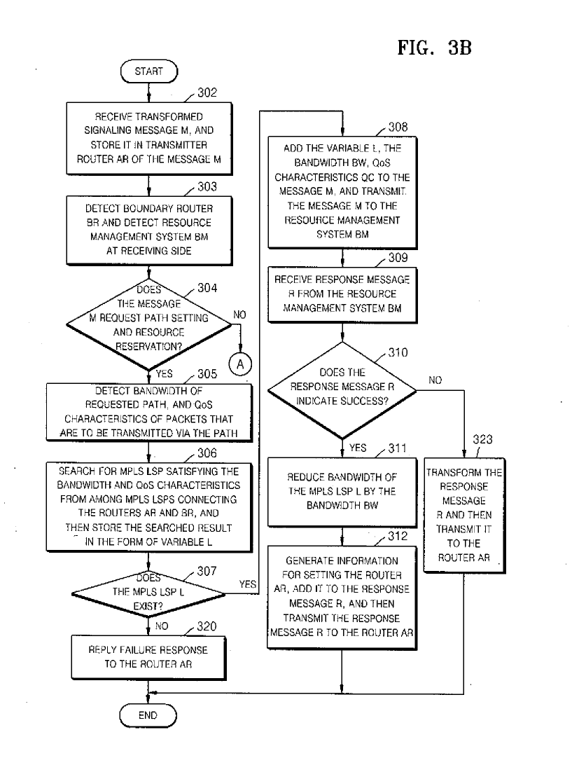

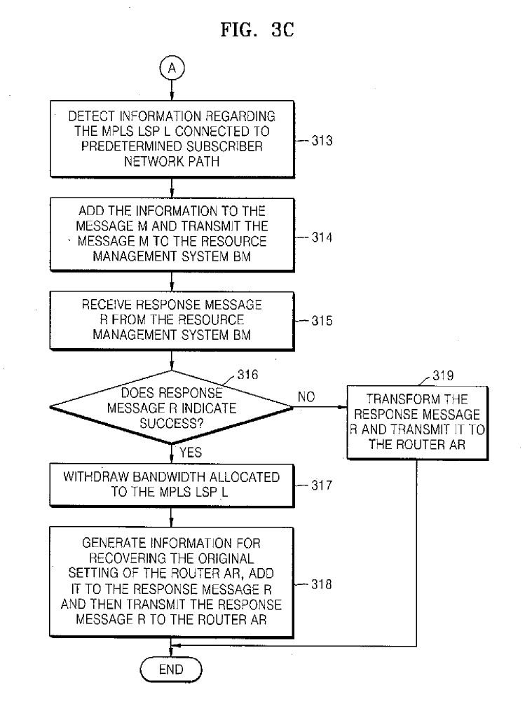

FIGS. 3A through 3C are flowcharts illustrating a method of allowing the resource management system A 130 of FIG. 1 to process a message received from the transmission network boundary router A 120 of FIG. 1, according to an embodiment of the present invention.

Referring to FIGS. 1 and 3A, the resource management system A 130 receives a signaling message transformed by the transmission network boundary router A 120 (operation 320). Then, the resource management system A 130 identifies a subscriber network in which a target terminal of the signaling message is located but the transmission network boundary router A 120 is not located where from the transformed message, and then detects the resource management system B 150 and the transmission network boundary router B 140 that are installed to the identified subscriber network (operation 330). If the signaling message contains information for path setting and resource reservation, the QoS characteristics of packets that are to be transmitted using the bandwidth of the path requested by the signaling message and via the path are detected based on the contained information (operation 340). Next, an MPLS LSP L 180 is searched for from among MPLS LSPs connected to the transmission network boundary router B 140 belonging to the subscriber network, the searched result is added to the transformed message and then the message is transmitted to the resource management system B 150 belonging to the subscriber network (operation 350). If a “success” response message to the transmitted message is received, an available bandwidth of the searched MPLS LSP L 180 is reduced and then information for setting the transmission network boundary router A 120 such that packets transmitted via the subscriber network can be transmitted via a corresponding MPLS LSP is generated (operation 360). Thereafter the generated information is added to the response message and then the response message is transmitted to the transmission network boundary router A 120 (operation 370).

FIGS. 3B and 3C are flowcharts illustrating in detail the method illustrated in FIG. 3A. If receiving a signaling message M transformed by a transmission network boundary router AR, a resource management system AM stores information regarding a transmitter of the signaling message M in the router AR (operation 302). Here, “AR” denotes either a transmission network boundary router or a variable corresponding thereto. Hereinafter, each variable will be used to denote either a system or a resource, or a variable indicating the system or the resource. Then a subscriber network in which a target terminal of the signaling message M is located is identified, and a resource management system BM and a transmission network boundary router BR that are installed in the identified subscriber network are detected (operation 303).

Next, it is determined whether the signaling message M instructs path setting and resource reservation, or canceling of a set path or resource withdrawal (operation 304). If the signaling message M instructs path setting and resource reservation, information recorded in the signaling message M is read in order to determine the QoS characteristics QC of packets that are to be transmitted using a bandwidth BW of a path instructed in the signaling message and transmitted via the path (operation 305).

Then an MPLS LSP having available bandwidth equal to or greater than BW, and the QoS characteristics QC is searched for from among MPLS LSPs connecting transmission network boundary routers AR and BR, and then the searched result is stored in the form of a variable L (operation 306). If no searched result is obtained in operation 307, a “FAILURE” message is replied to the transmission network boundary router AR (operation 320). If a searched result is obtained in operation 307, the variable L is added to the signaling message M and then the signaling message M is transmitted to the resource management system BM (operation 308).

If a response message R to the signaling message is received (operation 309), the resource management system AM determines whether the response message R indicates “SUCCESS” or “FAILURE” (operation 310). If the response message R indicates “FAILURE, the resource management system BM directly transforms the response message R and then transmits it to the transmission network boundary router AR (operation 323). If the response message R indicates “SUCCESS”, the available bandwidth of the searched MPLS LSP L is reduced by BW (operation 311). Thereafter information for setting the transmission network boundary router AR is generated so that packets transmitted via a path A in a subscriber network A, which is to be set according to the signaling message M, can be transmitted via the MPLS LSP L, the information is added to the response message R and then the response message is transmitted to the transmission network boundary router AR (operation 312).

Referring to FIG. 3C, if the signaling message M instructs canceling of a set path or reservation withdrawal (operation 304), the information previously stored in the resource measurement system AM is searched for, and then information regarding the MPLS LSP L connected to the subscriber's path A 170 corresponding to the searched information is detected (operation 313). Next, the detected information is added to the signaling message M and then the signaling message M is delivered to the resource management system BM (operation 314). Next, a response message R to the signaling message M is received from the resource management system BM (operation 315). If the response message R indicates “SUCCESS” (operation 316), the bandwidth allocated to the MPLS LSP L is withdrawn (operation 317). Then information for recovering the original setting of the router AR that was determined before path setting, the generated information is included into the response message R, and then the response message R is transmitted to the router AR (operation 318). If the response message R indicates “FAILURE”, the response message R is directly transmitted to the router AR without bandwidth withdrawal (operation 319).

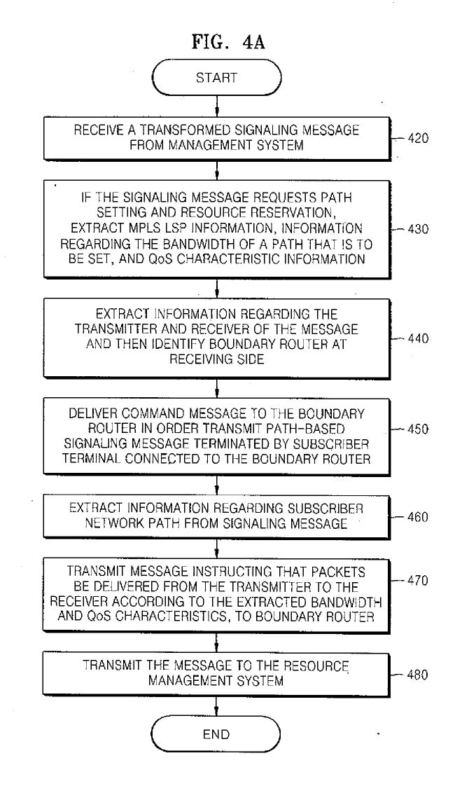

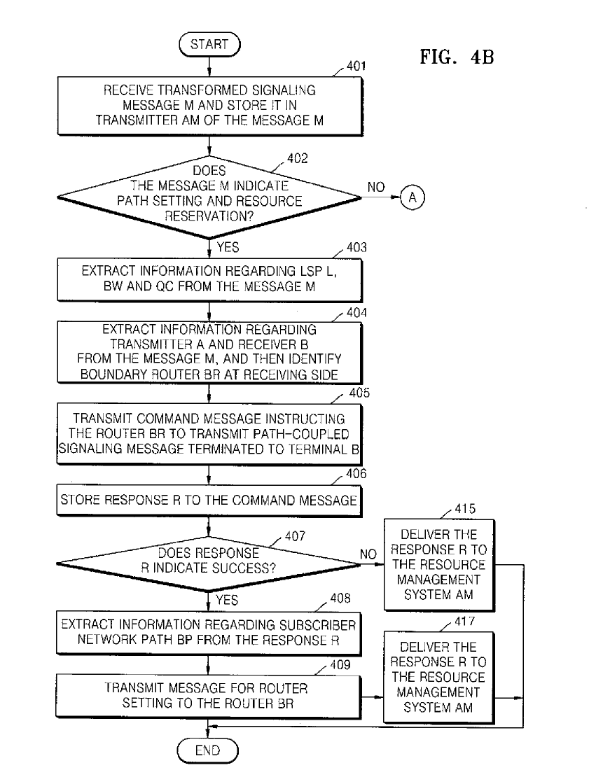

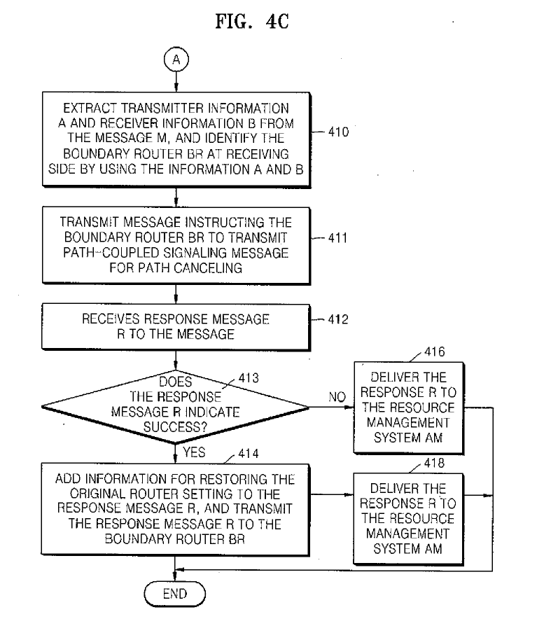

FIGS. 4A through 4C are flowcharts illustrating a method of allowing the resource management system B 150 to process a message received from the resource management system A 130, according to an embodiment of the present invention.

Referring to FIG. 4A, the resource management system B 150 receives a transformed signaling message from the resource management system A 130 (operation 420). If the received signaling message requests path setting and resource reservation, MPLS LSP information, information regarding the bandwidth of a path that is to be set, and QoS characteristic information are extracted from the message (operation 430). Next, information regarding the subscriber terminal 110 transmitting the message and the subscriber terminal 160 receiving the message are extracted from the signaling message in order to identify the boundary router B 140 at a receiving side (operation 440). Next, a command message is delivered to the boundary router B 140 in order transmit a path-coupled signaling message terminated by the subscriber terminal 160 connected to the boundary router B 140, using the identified information (operation 450).

If a response message to the command message is “success”, information regarding the path B 190 in a subscriber network B is extracted from the signaling message (operation 460). Next, a message instructing that packets from the subscriber terminal 110 (transmitter) be delivered to the subscriber terminal 160 (receiver) according to the extracted bandwidth and QoS characteristics, is delivered to the boundary router B 140 at the receiving side, which corresponds to the subscriber network (operation 470). Thereafter, the message is also delivered to the resource management system A 130 (operation 480).

FIGS. 4B and 4C are flowcharts illustrating in detail the method of FIG. 4A.

If receiving a transformed signaling message M from the resource management system AM 130, the resource management system B 150 records information regarding the transmitter of the message M in the resource management system AM 130 (operation 401). Here, “AM” denotes a variable indicating either the resource management system A 130 that transmits the message M or the resource management system A 130. Similarly, other variables must be understood as either a system or a resource, or a variable denoting the system or the resource.

Then, it is determined whether the signaling message M requests path setting or resource reservation (operation 402). If the signaling message M requests path setting or resource reservation, the resource management system B 150 extracts MPLS LSP information from the message M, stores it in the form of a variable L, extracts information regarding the bandwidth and QoS characteristics of a path that is to be set, and then respectively stores them in the form of variables BW and QC (operation 403). Next transmitter terminal information A and receiver terminal information B of the message M are extracted from the message M, and then a boundary router BR at a receiving side is identified using the extracted information A and B (operation 404). Next, a command message that instructs the boundary router BR to transmit a path-coupled signaling message, which is terminated from the boundary router BR to a terminal B, according to the information A and B (operation 405). The path B 190 that is to be set using the signaling message M has the bandwidth BW and the QoS characteristics QC.

Then a response message R to the message M is received from the boundary router BR, and stored in the form of a variable R (operation 406). If the response message R indicates “SUCCESS”, it means that a receiver path is appropriately set in a subscriber network B, and therefore information regarding a subscriber network path BP set in the subscriber network B is extracted from the response message R (operation 408). Next a message for router setting is made so that packets from among packets transmitted via the MPLS LSP L, which are transmitted from the terminal A to the terminal B and have the QoS characteristics QC, can be transmitted via the subscriber network path BP, and then is delivered to the transmission network boundary router BR (operation 409). Then the response message R is delivered to the resource management system A 130 (operation 417).

If the message M requests canceling of a set path and reservation withdrawal (operation 402), the resource management system B 150 extracts transmitter terminal information from the message M and stores it in the form of a variable A, extracts destination terminal information from the message M and stores it in the form of a variable B, and then identifies the boundary router BR at the receiving side by using the extracted information (operation 410 of FIG. 4C). Then the resource management system B 150 transmits a command message instructing that the boundary router BR transmit a path-coupled signaling message for canceling a path that has been set in subscriber network B to the terminal B (operation 411). Next the resource management system B 150 receives a response message R to the command message (operation 412). If the response message R indicates “SUCCESS”, it means that the subscriber network path has been normally canceled, and thus information for restoring the original setting of the router that was changed during path setting is added to the response message R and the response message R is transmitted to the boundary router BR (operation 414). Then the response message R is delivered to the resource management system AM (operation 418). If the response message R indicates “FAILURE”, it is directly delivered to the resource management system AM (operation 416).

In general, if a path or a network resource therefor is set or canceled using path-coupled signaling, effective management of the network resource is not only difficult but also system scalability is degraded due to the overhead incurred. In particular, if requests for path/resource setting from various terminals are directly processed in a transmission network in which a large amount of data is distributed, costs for management of the transmission network is increased. Thus there is a need for development of a method of effectively processing requests for path or resource reservation/cancellation from terminals which are connected to the transmission network via a subscriber network. The above methods according to the present invention allow such requests to be effectively processed.

It would be apparent to those of ordinary skill in the art that each of the operations of the methods according to the present invention can be variously realized in a software or hardware manner, using a general programming method.

The present invention can be embodied as computer readable code in a computer readable medium. Here, the computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable medium can be distributed among computer systems that are interconnected through a network, and the present invention may be stored and implemented as computer.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of allowing a router located between a subscriber network supporting path-coupled signaling and a transmission network to process a signaling message delivered from the subscriber terminal, together with a resource management system managing resources connected between the subscriber network and the transmission network, the method comprising:
the router transforming a path-coupled signaling message received from the subscriber terminal, and delivering the transformed message to the resource management system;
the resource management system receiving the transformed message, performing an operation instructed in the signaling message, and delivering a response message to the signaling message to the router; and
the router transforming the response message into a path-coupled signaling protocol response message corresponding to the subscriber terminal, and delivering the transformed response message to the subscriber terminal.

2. The method of claim 1, wherein if the response message delivered to the router indicates that the operation instructed in the signaling message has been successfully performed, the response message comprises information indicating the change of the router's setting.

3. A method of allowing a first resource management system managing resources connected between a first subscriber network supporting path-coupled signaling and a transmission network to process a message transmitted from a router located between the first subscriber network and the transmission network, the method comprising:
receiving a transformed signaling message from the router;
identifying a second subscriber network in which a destination terminal of the signaling message is located, and detecting a second resource management system and a second transmission network boundary router installed to correspond to the second subscriber network, based the signaling message;
if the signaling message contains information for path setting and resource reservation, detecting a bandwidth of a path requested in the signaling message and QoS (quality of service) characteristics of packets that are to be transmitted via the path, from the contained information;
searching for a MPLS (Multi-Protocol Label Switching) LSP (Label-Switched Path) from among MPLS LSPs connecting the router and the second transmission network boundary router corresponding to the second subscriber network, adding the searched result to the received message, and then delivering the resultant message to the second resource management system corresponding to the second subscriber network;
if a response message to the delivered message indicates success, reducing a bandwidth available of the searched MPLS LSP, and generating information for router setting in order to transmit packets received from the subscriber network via the searched MPLS LSP; and
adding the generated information to a response message and then delivering the response message to the router.

4. The method of claim 3, wherein the delivering of the resultant message to the second resource management system comprises searching for an MPLS LSP according to the available bandwidth and the QoS characteristics.

5. The method of claim 3, wherein if a response message to the delivered message indicates a failure, delivering the response message to the router without the information needed to change the settings of the router.

6. The method of claim 3, wherein if the signaling message contains information for canceling of a set path or resource withdrawal, the detecting of the QoS characteristics comprises adding information regarding an MPLS LSP connected to a path in the first subscriber network, which has been stored in the resource management system, into the signaling message; delivering the signaling message to a predetermined resource management system; withdrawing a bandwidth allocated to the MPLS LSP if a response message to the signaling message indicates a success; generating information for recovering the original setting of the router that has been determined prior to setting of the path; adding the generated information to a response message; and then delivering the response message to the router.

7. The method of claim 6, wherein if the response message to the signaling message to which the stored information regarding the MPLS LSP is added indicates a failure, delivering the response message to the router without withdrawing the bandwidth allocated to the MPLS LSP.

8. A method of allowing a first resource management system connected between a subscriber network supporting path-coupled signaling and a transmission network to process a path-based message received from a second resource management system, the method comprising:
receiving a transformed signaling message from the second resource management system;
if the received signaling message requests path setting and resource reservation, extracting multi-protocol label switching (MPLS) label-switched path (LSP) information and information regarding a bandwidth and QoS (quality of service) characteristics of a path that is to be set from the signaling message;
extracting information regarding a transmitter terminal and a receiver terminal of the signaling message from the signaling message, and identifying a boundary router at a receiving side;
sending the boundary router with a command message instructing a path-coupled signaling message, which is terminated by a subscriber network terminal connected to the boundary router, to be transmitted using the extracted information;
if a response message to the command message indicates a success, extracting information regarding a subscriber network path formed in the subscriber network from the signaling message; and
transmitting a reply message to the second resource manager, which corresponds to the subscriber network of the transmitter terminal, so that packets are to be delivered from the transmitter terminal to the receiver terminal according to the extracted bandwidth and QoS characteristics.

9. The method of claim 8, wherein if the received signaling message requests path canceling and resource withdrawal, the sending of the command message comprises extracting the first resource management system extracts information regarding a transmitter terminal and a receiver terminal from the command message and then identifying the boundary router at the receiving side.

10. The method of claim 9, wherein the sending of the command message comprises identifying the boundary router at the receiving side, and sending the boundary router the command message instructing a path-coupled signaling message for canceling a predetermined path in a subscriber network corresponding to the receiver terminal be transmitted to the receiver terminal.

11. The method of claim 10, wherein if a response message to the transmitted signaling message indicates a success, information for recovering the original setting of the router that has been changed during path setting is added to the response message and then the response message is transmitted to the boundary router at the receiving side; and then delivering a response message to the second resource manager to indicate that the path is successfully cancelled.
